(19) United States
(12) Patent Application Publication
(10) Pub. No.: US 2010/0295766 A1
(43) Pub. Date: Nov. 25, 2010

(54) WHITE BACKLIGHT FOR A DISPLAY

(75) Inventors: Luigi Albani, Merate (IT); Carlo Casale, Busto Arsizio (IT); Denis De Monte, Forni Di Sotto (IT); Paulus Aerssens, Landgraaf (NL)

Correspondence Address: PHILIPS INTELLECTUAL PROPERTY & STANDARDS, P.O. BOX 3001, BRIARCLIFF MANOR, NY, 10510, US

(73) Assignees: Koninklijke Philips Electronics N.V., Eindhoven (NL); Professional Display Systems B.V., Heerlen (NL)

(21) Appl. No.: 12/600,092

(22) PCT Filed: May 14, 2008
(86) PCT No.: PCT/IB2008/051893

§ 371 Date: Dec. 8, 2009

(30) Foreign Application Priority Data
May 16, 2007 (EP) 07108379.4

(51) Int. Cl. G09G 3/36

(52) U.S. Cl. 345/102

(57) ABSTRACT

A display backlight is described which produces white light of a specified color point and from light sources of different chromaticities and in which the red wavelengths emitted by the light sources are emitted by light sources of two or more chromaticities from the group of at least three different chromaticities and arranged to be driven with the result that visible, red-colored artifacts are reduced at boundaries of high image contrast when the backlight is coupled to further display components and used for display of a grey scale image. The invention allows production of a display with an adjustable white color point but which also does not suffer from distracting red, fringe-like artefacts reported by users of displays comprising white backlights produced from red, green and blue light sources. A display incorporating the backlight is also described.

### FIELD OF THE INVENTION

The invention relates to a display backlight to produce white light of a specified color point, comprising an arrangement of light sources, the chromaticities of which are selected from a group of at least three different chromaticities, the light sources coupled to an arrangement for transmitting the light emitted from the light sources to further display components, which arrangement mixes the emitted light to produce white light of the specified color point, wherein the chromaticity coordinates of the group of at least three different chromaticities, when plotted on the 1976 CIE U.S.C. Chromaticity Diagram, form the vertices of a shape with at least three sides which shape further surrounds the point on the diagram which describes the specified color point.

### BACKGROUND OF THE INVENTION

It is known in the field of displays to produce a display backlight, arranged to produce white light, using colored light sources. Commonly in such a case, separate light sources of different chromaticity are used, each source emitting light in either the red, green or blue portions of the visible spectrum. As is known in the art, when the chromacities of the light sources are plotted, on either the C.I.E. 1976 U.S.C. or 1931 Chromaticity Diagrams, a shape is formed, which is triangular in the case of three chromaticities and which includes within its boundaries the entire set of colors, or color gamut, potentially reproducible through specific combinations of the set of colored red, green and blue lights. The color gamut includes variations of white, as seen in the central portion of the Chromaticity Diagram. Further, adjustment of the relative intensities or outputs of the red, green and blue sources alters the overall color produced by the combination. It is therefore possible to use red, green and blue light sources to produce not only white light, but white light with an adjustable color point.

Typically within the backlight, the light emitted from the colored sources is transmitted to an arrangement, frequently referred to as a light guide, where it is mixed, usually due to total internal reflection, to produce white light for illumination of the further elements of the display. The remainder of the display is typically an LCD display, as is known in the art, in which the backlight illuminates the LCD display typically from the rear or from the side, but can also be other types of display including, for example, scanning displays using micro-mirrors, and also LCD based projectors and LCOS projectors.

Displays incorporating white backlights are particularly useful for the display of digital medical images derived from digital X-ray imaging, computerized tomography, nuclear magnetic resonance imaging, nuclear medicine imaging including positron emission tomography, ultrasound and other methods of imaging arranged to provide images of the internal aspects of the human body. Such images are traditionally viewed using grey scale images, reflecting the acquired expertise of the radiology profession acquired over decades through the viewing of X-ray films, and as such can be advantageously viewed on a grey scale display monitor with a white backlight.

The adjustability of the white point on such medical monitors is used to solve a further problem, specific to medical imaging and occurring when two or more displays are placed side by side for the purposes of viewing multiple patient images in large format. As is known in the art, the white points of white backlights used for grey scale displays can vary, while each still appearing white when viewed in isolation. When two or more grey scale displays are viewed together, any variation in their white points will become noticeable and distracting, with each display appearing to take on a colored cast in relation to each other display. Thus one display may appear to have a reddish colored cast in relation to a second, the second appearing to have a bluish cast, say, in relation to the first. The adjustability of the white point, due to the use of distinctly and separately red, green and blue colored light sources, allows the white points of any displays used together to be tuned to each other or to any common white point. Thus two or more displays can be tuned to the same white point thereby removing the distracting color cast that potentially occurs with untuned displays.

WO 01/84225 describes a system in which red, green and blue LEDs are used to produce a white colored backlight with adjustable white point.

Although red, green and blue light sources can be combined to produce a white backlight with adjustable white point a strange visual artefact has been noticed by viewers using monitors which comprise such backlights. When red, green and blue light sources are used to produce a white backlight, red colored fringes are visible in displayed images at high contrast boundaries, most noticeable at the boundaries between black areas and white areas, but also visible to some extent between dark grey and light gray areas. Unfortunately, it is found that once the artefacts have been noticed by a particular viewer, and they are more noticeable to viewers wearing glasses, it is difficult for the viewer to avoid seeing them. There are reports of viewers repeatedly distracted by the red colored artefacts once they realize that the artefacts are visible in display images. In particular, this is highly distracting for the medical user of grey scale displays while he or she is trying to focus on areas of contrast variation for the purposes of lesion identification and general diagnosis.

### SUMMARY OF THE INVENTION

This problem is solved by the invention whereby the red wavelengths emitted by the light sources are emitted by light sources of two or more chromaticities from the group of at least three different chromaticities and arranged to be driven with the result that visible, red-colored artifacts are reduced at boundaries of high image contrast when the backlight is coupled to further display components and used for display of a grey scale image.

### DETAILED DESCRIPTION

The feature of distributing the red wavelengths over more than one type, or color, of light source, while mixing the light from the light sources to produce white light of a specified color point, requires the user, in order to achieve the specified white point, to drive the light sources emitting a spectrum which is mostly or entirely red light at a lower output in relation to the output of the other light sources. The lower output of red light from the light sources which emit mostly red light or light at the red end of the visible spectrum reduces the red artefacts as are seen on grey scale images displayed on monitors which utilize a white backlight comprising red, green and blue light sources.

There are several ways to reduce the output of the light sources which emit mostly or entirely red light. For example, distributing the red wavelengths over more than one color of light source, while maintaining the specified white color point, means that the light source contributing the most intense red wavelengths can be driven at a lower intensity, thereby producing a backlight which does not produce noticeable red artifacts.

A further way to reduce output at the red end of the overall spectrum emitted by the light sources is to construct the backlight in such a way that the number of individual light sources with a chromaticity positioned in or towards the red portion of the CIE U.S.C. Chromaticity Diagram is less than the number of light sources of each of the remaining chromaticities. In other words, a backlight is constructed with fewer individual light sources emitting mostly red light than light sources with any other chromaticity as plotted on the Chromaticity Diagram.

A further embodiment which reduces the output at the red end of the overall spectrum emitted by the light sources is to construct a backlight in such a way that the light sources with a chromaticity positioned in or towards the red portion of the CIE U.S.C. Chromaticity Diagram are chosen so that they have a reduced saturation, or purity, in comparison with the light sources of the remaining chromaticities. This embodiment is advantageous because saturated colored light is not required in order to produce a white backlight from a combination of colored lights. It enables a solution to be produced using low saturation light sources while still maintaining adjustability of the white point and reduction or removal of the red artefacts, seen when red, green and blue light sources are used.

Alternatively, a further embodiment includes light sources selected and driven so that the light sources with a chromaticity positioned in or towards the red portion of the CIE 1976 U.S.C. Chromaticity Diagram are driven in such a way that the photometric power contribution at wavelengths longer than or equal to 630 nm is a small percentage of the overall power. In a particularly advantageous embodiment the photometric power of the light sources emitting red light is less than or equal to 5% of the overall power of the light sources.

In the above, red light includes light with a wavelength above 590 nm, and particularly above 615 nm. Although the invention has been described in terms of the CIE 1976 U.S.C. Chromaticity Diagram, it will be clear to the person skilled in the art that the CIE 1931 Chromaticity Diagram could be used instead, the two being equivalent diagrams of chromaticity.

The use of white light sources in the backlight, in other words sources of a chromaticity which can be plotted in the white portion of the 1976 CIE U.S.C. Chromaticity Diagram, has been found to be particularly useful and it is believed that this is because the spectrum of light which appears white contains a portion of red wavelengths. White light typically contains a sufficient proportion of red light for adjustability of the white point to be maintained while allowing the red or predominantly red light sources to be driven at a lower output.

White light is also typically relatively unsaturated and in combination with unsaturated lights covering mostly the red end of the visible spectrum can, in addition with lights of one other chromaticity produce a backlight which has good white point adjustability while avoiding the red fringe-like artefacts.

The features of the invention allow production of a white backlight for a display, with adjustable white point, but which does not suffer from, or which at least suffers less from, the red-colored artefacts, seen as red colored fringes.

In the above description, the problem to be solved has been discussed in terms of the reduction of the described red artefacts, and not in terms of their total removal. This is because although if the instructions in the text are followed, a backlight can be constructed which does not suffer from noticeable, distracting red, fringe-like artefacts situated at boundaries of high contrast, concerted and detailed examination of the resulting display screen with optical equipment may indeed reveal residual red fringes under magnification, not normally noticeable with the naked eye, with or without prescription glasses. The purpose of this invention is to produce a backlight which when coupled to a suitable display does not produce noticeable and distracting fringe-like, red artefacts produced at the high contrast boundaries between image areas of widely differing grey level. Therefore the problem to be solved is the reduction of these artefacts.

The light sources can be any light source suitable for providing illumination for a backlight and include, for example but not exclusively, incandescent light bulbs and electroluminescent sources such as, for example, LEDs. LEDs are commonly used today because of their cheapness and the ease of their manufacture. The recent development of high intensity LEDs allows their inclusion into a high brightness backlight for the purposes of high brightness and high contrast displays for medical applications. As is also known in the art, when LEDs are used to form the backlight other components are included in the optical path in order to produce a backlight of sufficient illumination, for example, diffusers.

When LEDs are used as the light sources for the backlight it is found that a white backlight with adjustable white point, and without visible red artefacts at boundaries of high contrast can be produced with a backlight comprising an arrangement of blue, white and amber LEDs. In particular it is found that the blue LEDS should have a dominant wavelength in the range from 460-490 nm, the amber LEDs a dominant wavelength in the range from 584-597 nm, and the white LEDs a white point with chromaticity co-ordinates in the C.I.E. 1931 Chromaticity Diagram in the range of 0.301<x<0.316 and 0.322<y<0.355. However, even better results are found when the blue LEDS have a dominant wavelength in the range from 475-485 nm, the amber LEDs have a dominant wavelength in the range from 592-597 nm and the white LEDs have a white point with chromaticity co-ordinates in the C.I.E. 1931 Chromaticity Diagram in the range of 0.301<x<0.316 and 0.322<y<0.355. Such a backlight can be constructed which offers adjustable white point and no visible red artefacts at boundaries of high contrast when coupled to further components to produce a display monitor.

However, due to constraints on the efficiency of amber LEDs currently commercially available, it is found that a particularly advantageous embodiment at the time of writing and applicable when LEDs are used as the light sources for a white backlight with adjustable white point, and without visible red artefacts at boundaries of high contrast, is a backlight comprising an arrangement of blue, white and red-orange LEDs. In this case it is found that the blue LEDS should have a dominant wavelength in the range from 460-490 nm, the red-orange LEDs a dominant wavelength in the range from 613-621 nm and white LEDs a white point with chromaticity co-ordinates in the C.I.E. 1931 Chromaticity Diagram in the range of 0.301<x<0.316 and 0.322<y<0.355. However it is found that even better results are found when the blue LEDS have a dominant wavelength in the range from 475-485 nm, the red-orange LEDs a dominant wavelength in the range from 613-621 nm, and the white LEDs a white point with chromaticity coordinates in the C.I.E. 1931 Chromaticity Diagram in the range of 0.301<x<0.316 and 0.322<y<0.355. Again, it is found that a backlight with these constraints can be constructed which offers adjustable white point and no visible red artefacts at boundaries of high contrast when coupled to further components to produce a display monitor.

A further solution can be found with a backlight comprising specifically four chromaticities, in this case the LEDs being blue, green, red-orange and amber. In this case it is found that the blue LEDS should be of dominant wavelength in the range from 460-490 nm, the green LEDs of dominant wavelength in the range from 520-550 nm, the red-orange LEDs of dominant wavelength in the range from 613-621 nm, and the amber LEDs of dominant wavelength in the range from 584-597 nm. But it is found that particularly good results are achieved when the blue LEDS have a dominant wavelength in the range from 475-485 nm, the green LEDs have a dominant wavelength in the range from 540-550 nm, the red-orange LEDs have a dominant wavelength in the range from 613-621 nm, and the amber LEDs a dominant wavelength in the range from 592-597 nm. Again, as before, this combination allows construction of a backlight which offers adjustable white point and no visible red artefacts at boundaries of high contrast when coupled to further components to produce a display monitor.

It is also found that a solution can be found when the LEDs include combinations of red and amber LEDs, driven at appropriate levels to produce red light but without producing the red artefacts. In general, as described above, this will require both types of LED, which are both positioned in or towards the red portion of the CIE 1976 U.S.C. Chromaticity Diagram, to be driven at relatively lower intensities, or driven at similar intensities but selected so that they are lower in number, than the LEDs of other chromaticity comprised in the solution according to the invention.

As is known in the art, when using LEDs as the light source for a backlight each can be driven at a lower output in one of two ways, firstly by driving it at a lower driving level, or operating current, and secondly by reducing the time for which it is turned on. Once the person skilled in the art is aware which features will provide a solution to the red artefacts, he will be able to construct a suitable set of driving levels and on/off times for an array of suitably selected LEDs which reduces or removes the red artefacts while maintaining an adjustable white point for the overall light output from the backlight to the further display components.

As is known, and has been mentioned, the chromaticities of the light sources used in the backlight can be described by their coordinates on either the C.I.E. 1976 U.S.C. or 1931 Chromaticity Diagram, and in each case forms a shape in the Diagram, the shape being a triangle, or three sided shape, in the case of three separate chromaticities and a four sided shape in the case of four chromaticities.

In the examples above it including white light can be seen that the chromaticites of the combinations of LEDs form smaller triangles than the known combination of red, green and blue light sources. The use of smaller color triangle means a lower number of reproducible colors, and as a consequence, the further advantage that the same quantization error in the LED driving circuit which will result in better color point accuracy. The smaller triangle, however, also infers a smaller color gamut on the overall monitor, but this is acceptable because the colored light sources are used to create a white point. In fact, the reduced color gamut allows greater accuracy in the control of each color point. For use with a display intended for grey scale images only, the reproduction of the full range of color is not necessary. In addition, in the case where the light sources are LEDs, the smaller triangle has the extra advantage that as the backlight ages and the LEDs age at different rates, causing gradual alteration of the white point, the use of LEDs with color points forming a smaller triangle has the consequence that the white point will alter over a smaller range and therefore will allow production of a more consistent backlight.

However, a backlight according to the invention is not restricted to the display of grey scale images alone and in particular, the backlight according to the invention can be used with colored LCD displays, which as is known in the art typically incorporate red, green and blue filters for the production of colors across a large color gamut. Even without the addition of a colored LCD display, the combination comprising blue, green, red-orange and amber LEDs allows production of a wide range of colors and this solution can be used to generate a colored display. This is particularly advantageous when used in a display monitor intended for medical purposes where grey scale images will be displayed which include areas of added color, for example in doppler ultrasound imaging which, for example, superimposes a colored image depicting flow information, for example blood flow, onto a grey scale ultrasound image depicting patient anatomy.

The invention also relates to a display, in particular a medical display, comprising a backlight to produce white light of a specified color point, and comprising an arrangement of light sources, the chromaticities of which are selected from a group of at least three different chromaticities, the light sources coupled to an arrangement for transmitting the light emitted from the light sources to further display components, which arrangement mixes the emitted light to produce white light of the specified color point, and wherein the chromaticity coordinates of the group of at least three different chromaticities, when plotted on the 1976 CIE U.S.C. Chromaticity Diagram, form the vertices of a shape with at least three sides which shape further surrounds the point on the diagram which describes the specified color point, and further in which the red wavelengths emitted by the light sources are emitted by light sources of two or more chromaticities from the group of at least three different chromaticities and arranged to be driven with the result that visible, red-colored artifacts are reduced at boundaries of high image contrast when the backlight is coupled to further display components and used for display of a grey scale image.

Such a display, and in particular if it is a medical display, is particularly suited to display images in grey scale in which an adjustable white point is achieved and which do not suffer the red, fringe-like artefacts visible when red, green and blue light sources, in particular LEDs, are used to produce the backlight of adjustable white point.

### BRIEF DESCRIPTION OF THE DRAWINGS

These and other aspects of the invention will be explained with the aid of the following figures.

FIG. 1 is a reproduction of a binary test pattern showing black and white circles displayed each on a negative background, displayed using a white backlight comprising red, green and blue LEDs and which reveals the existence of red fringe-like artefacts at the boundaries between the areas of high contrast.

FIG. 2 is a reproduction of a test pattern showing areas of black, white and various grey levels, displayed using a white backlight comprising red, green and blue LEDs and which reveals the existence of red fringe-like artefacts at the boundaries between the areas of high, but also reasonable high, contrast.

FIGS. 3a, b and c show possible embodiments of combinations of LED chromaticities, according to the invention.

FIGS. 4a and 4b shows two graphs showing the relative intensity of light output versus wavelength of light for two displays, both using a combination of red, blue and green LEDs, driven at two different white color points, which combinations both produce the red fringe-like artefacts.

FIGS. 5a and 5b shows two graphs showing the relative intensity of light output versus wavelength of light for two displays, both using a combination of red, white and blue LEDs, driven at two different white color points, both of which combinations do not produce the red fringe-like artefacts, according to the invention.

FIG. 6 shows the relative intensity of light output versus wavelength of light for a display using a combination of amber, white and blue LEDs. This combination does not produce the red fringe-like artefacts, according to the invention.

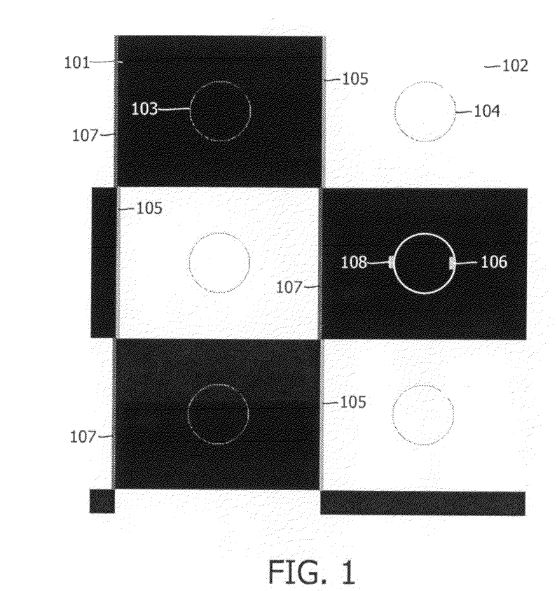

FIG. 1 is a reproduction of a binary test pattern showing black areas 101 interposed with white areas 102, the black areas 101 including white circles 103 and the white areas 102 including black circles 104. This figure is a reproduction of a test pattern displayed using a white backlight comprising red, green and blue LEDs and reveals the existence of red fringe-like artefacts 105 and 106 at the boundaries between the areas of high contrast, in other words between the black areas and the white areas. The long fringe-like structures 105 are visible between areas of black and white when the black areas 101 are positioned in the test pattern to the left hand side of, as viewed by the viewer, the right areas 102. Red artefacts are visible and can be viewed between any such areas.

Upon very close inspection it was found that blue fringe-like artefacts 107 and 108, occurred in the test pattern, seemingly equivalent to the red artefacts 105 and 106 and positioned at boundaries where the black areas 101 were positioned to the right hand side of the white areas 102. However, these were only identified during experimental work undertaken to solve the red artifacts, had not been reported by viewers of the backlights and were not found to be either noticeable or distracting. It is believed that the blue artefacts 107 and 108 are not distracting and pose little problem for the viewer because the contrast between blue and black is not as noticeable as the contrast between red and black.

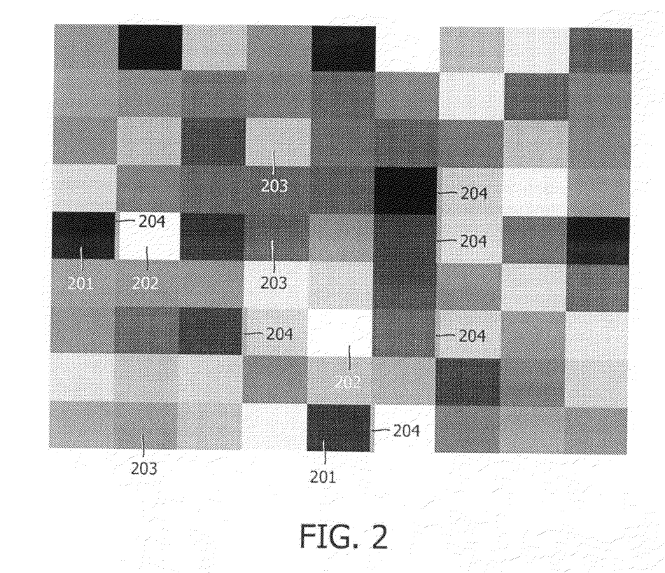

FIG. 2 is a reproduction of a test pattern showing areas of black 201, white 202 and various grey levels 203, displayed using a white backlight comprising red, green and blue LEDs. The test pattern reveals the existence of red, fringe-like artefacts 204 at the boundaries between the areas of high, but also of reasonably high, contrast. Thus, in this test pattern it was found that the red artefacts did not appear only between areas of black and white, but also at boundaries between areas of dark grey and of white, between areas of black and of light grey, and also, but sometimes to a less noticeable extent, between various areas of dark grey and light grey. The extent of the red artefacts seen by any one viewer depends partly on the particular visual perception of the viewer and therefore the red artefacts 204 depicted in the diagram are representative of those found in any real display utilizing red, green and blue light sources.

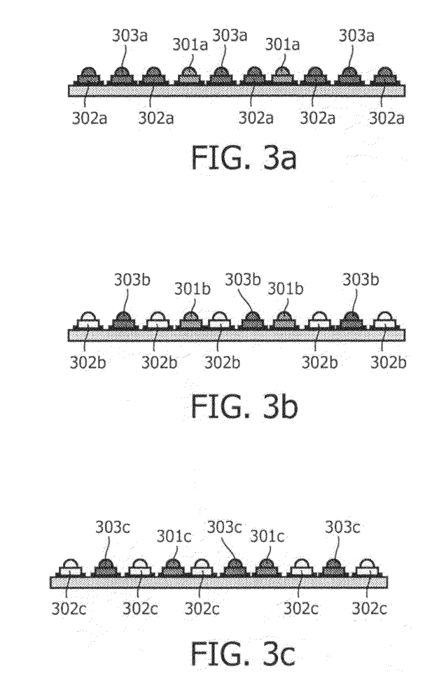

FIG. 3a shows a combination of LEDs of differing chromaticities, which can be combined in an appropriate manner, as known in the art, to produce a backlight with adjustable white point and which does not render grey scale images with red-colored artefacts. This combination shows amber 301a, green 302a and blue 303a LEDs in a combination in which there are a fewer number of amber LEDs than either the green or blue LEDs. The LEDs are shown in a line, however, as will be clear to the skilled person, LEDs can be physically combined in various geometrical arrangements to produce the light for a backlight, dependent on the particular light guide arrangement for the backlight in question.

FIG. 3b shows an alternative combination of LEDs of differing chromaticities, which can also be combined in an appropriate manner, to produce a backlight with adjustable white point and which does not render grey scale images with red-colored artefacts. This combination shows amber 301b, white 302b and blue 303b LEDs in a combination in which there are a fewer number of amber LEDs than either the white or blue LEDs.

FIG. 3c shows a further alternative combination of LEDs of differing chromaticities, which can also be combined in an appropriate manner, to produce a backlight with adjustable white point and which does not render grey scale images with red-colored artefacts. This combination shows red 301c, white 302c and blue 303c LEDs in a combination in which there are a fewer number of red LEDs than either the white or blue LEDs. In fact in a specific example, which produces a highly advantageous result, an arrangement of 40 high intensity LEDs was used, comprising 20 white LEDs, 12 blue LEDs and 8 red or red-orange LEDs. Although this specific combination was found to be highly satisfactory for the purposes of removing the red artefacts while maintaining adjustability of the white point, other similar numerical combinations would offer suitable results.

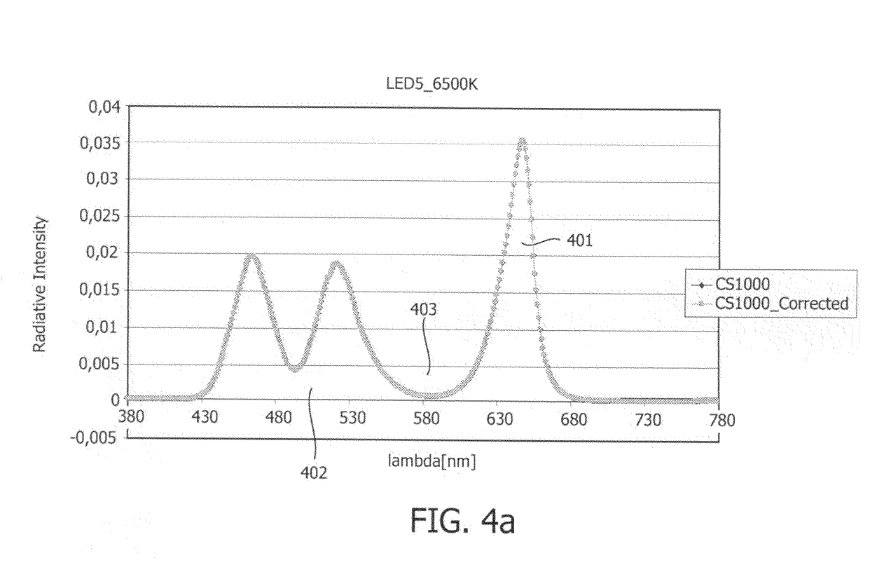

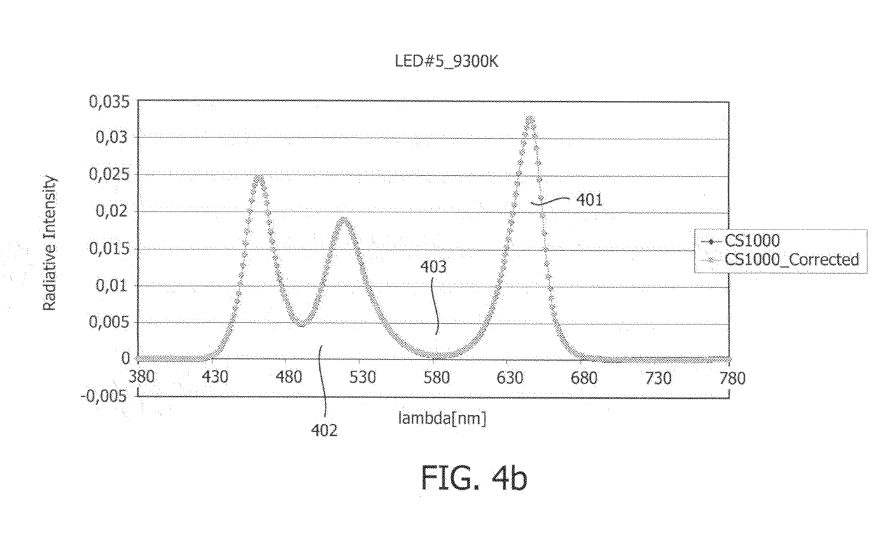

FIG. 4a is a graph showing the relative intensity of light output versus wavelength of light for a display using a combination of red, blue and green LEDs, driven to produce a white color point of 6500 K. FIG. 4b is a graph showing the relative intensity of light output versus wavelength of light for a display using a combination of red, blue and green LEDs, driven to produce a white color point of 9300 K. Both displays are known to produce red fringe-like artefacts. In both 4a and 4b, the light emitted at the red spectrum components 401 are separated from the blue and green spectrum components 402 by a gap 403.

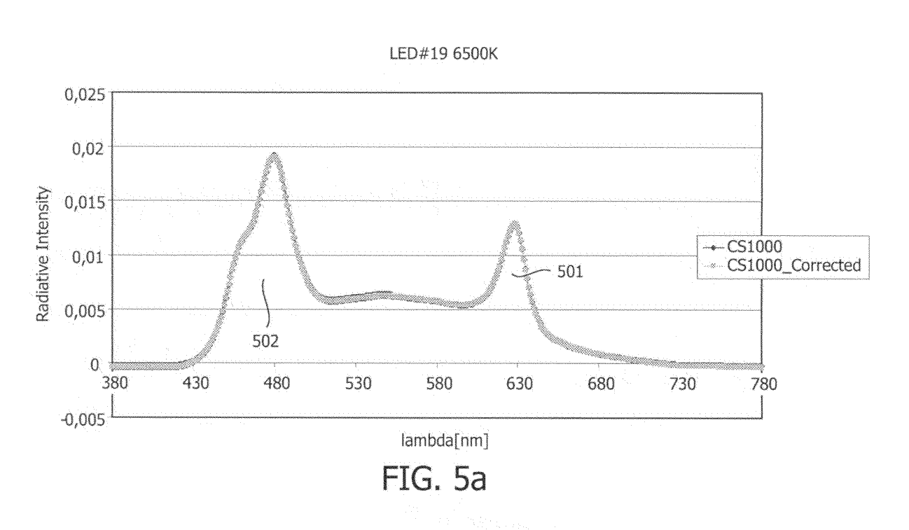

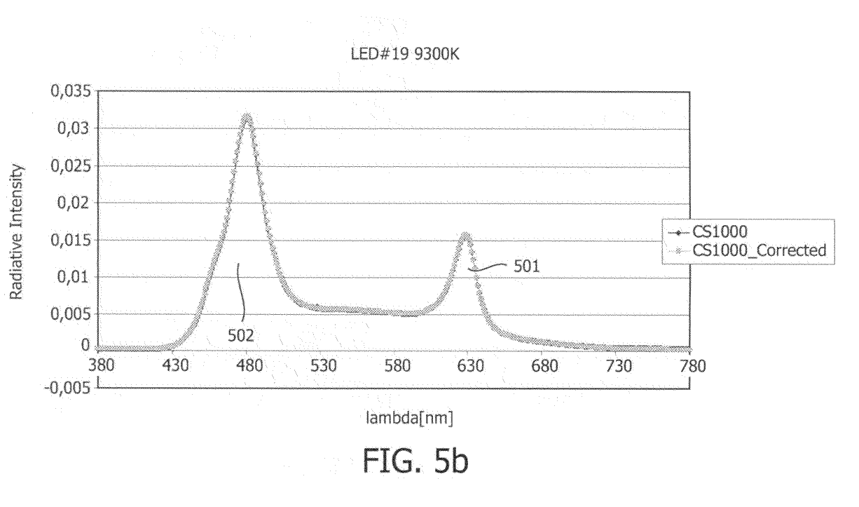

FIG. 5a is a graph showing the relative intensity of light output versus wavelength of light for a display using a combination of red, white and blue LEDs, driven to produce a white color point of 6500 K. FIG. 5b is a graph showing the relative intensity of light output versus wavelength of light for a display using a combination of red, white and blue LEDs, driven to produce a white color point of 9300 K. Neither combination produces the red fringe-like artefacts and so both can be used to produce a display with adjustable white point that is comfortable to view and not distracting. It can be seen in both graphs that there is no gap between the red portion of the spectrum 501 and the portion of the spectrum 502 which contributes to the blue and green portions of the spectrum.

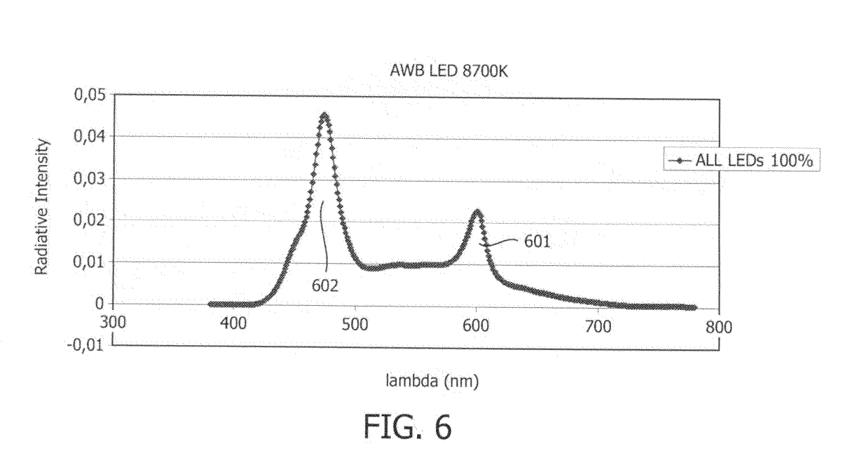

FIG. 6 shows the relative intensity of light output versus wavelength of light for a display using a combination of amber, white and blue LEDs. Again, it can be seen that the portion of the spectrum 601 covering the red wavelengths emitted overlaps with the portion of the spectrum 602 covering the blue and green portions of the emitted wavelengths. There is no noticeable gap. Again, this combination does not produce the red fringe-like artefacts, according to the invention.

Similar graphs can be generated for the combination comprising blue, white and red-orange LEDs.

In fact, in view of the contents of FIGS. 4, 5 and 6 is can also be seen that an alternative description of the invention is of a combination of light sources producing a spectrum of relative intensity of emitted light versus wavelength, in which there are no gaps in the spectrum between the short and middle wavelength portions of the spectrum and the long wavelength end of the spectrum. The absence of gaps in such a spectrum indicates that the red light is distributed over two chromaticities of light source and this reduces or removes the red fringes.

As will have been noticed by the person skilled in the art, the terms display and monitor have been used interchangeably.

1. A display backlight to produce white light of a specified color point, comprising an arrangement of light sources, the chromaticities of which are selected from a group of at least three different chromaticities, the light sources coupled to an arrangement for transmitting the light emitted from the light sources to further display components, which arrangement mixes the emitted light to produce white light of the specified color point, wherein the chromaticity coordinates of the group of at least three different chromaticities, when plotted on the CIE 1976 U.S.C. Chromaticity Diagram, form the vertices of a shape with at least three sides which shape further surrounds the point on the diagram which describes the specified color point, characterised in that the red wavelengths emitted by the light sources are emitted by light sources of two or more chromaticities from the group of at least three different chromaticities and arranged to be driven with the result that visible, red-colored artifacts are reduced at boundaries of high image contrast when the backlight is coupled to further display components and used for display of a grey scale image.

2. A display backlight as claimed in claim 1, wherein the light sources with a chromaticity positioned in or towards the red portion of the CIE 1976 U.S.C. Chromaticity Diagram are driven at a reduced intensity in comparison to the remaining light sources.

3. A display backlight as claimed in claim 1, wherein the number of individual light sources with a chromaticity positioned in or towards the red portion of the CIE 1976 U.S.C. Chromaticity Diagram is less than the number of light sources of each of the remaining chromaticities.

4. A display backlight as claimed in claim 1, wherein the light sources with a chromaticity positioned in or towards the red portion of the CIE 1976 U.S.C. Chromaticity Diagram are chosen so that they have a reduced purity in comparison with the light sources of the remaining chromaticities.

5. A display backlight as claimed in claim 1, wherein the light sources with a chromaticity positioned in or towards the red portion of the CIE 1976 U.S.C. Chromaticity Diagram are driven in such a way that the photometric power contribution at wavelengths longer than or equal to 630 nm is a small percentage of the overall power.

6. A display backlight as claimed in claim 5, wherein the small percentage is less than or equal to 5% of the overall power.

7. A display backlight as claimed in claim 1, wherein one chromaticity of the group of at least three chromaticities is in the white portion of the 1976 CIE U.S.C. Chromaticity Diagram.

8. A display backlight as claimed in claim 1, wherein the light sources are LEDs.

9. A display backlight as claimed in claim 8, wherein the group of at least three chromaticities include specifically three chromaticities which characterize the LEDs as being of types blue, white and amber.

10. A display backlight as claimed in claim 9 wherein the LEDs have the following characteristics—blue LEDS of dominant wavelength in the range from 460-490 nm, amber LEDs of dominant wavelength in the range from 584-597 nm, and white LEDs of white point with chromaticity co-ordinates in the C.I.E. 1931 Chromaticity Diagram in the range of 0.301<x<0.316 and 0.322<y<0.355.

11. A display backlight as claimed in claim 10 wherein the LEDs have the following characteristics—blue LEDS of dominant wavelength in the range from 475-485 nm, amber LEDs of dominant wavelength in the range from 592-597 nm, and white LEDs of white point with chromaticity co-ordinates in the C.I.E. 1931 Chromaticity Diagram in the range of 0.301<x<0.316 and 0.322<y<0.355.

12. A display backlight as claimed in claim 8, wherein the group of at least three chromaticities include specifically three chromaticities which characterize the LEDs as being of types blue, white and red-orange.

13. A display backlight as claimed in claim 12, wherein the LEDs have the following characteristics—blue LEDS of dominant wavelength in the range from 460-490 nm, red-orange LEDs of dominant wavelength in the range from 613-621 nm, and white LEDs of white point with chromaticity co-ordinates in the C.I.E. 1931 Chromaticity Diagram in the range of 0.301<x<0.316 and 0.322<y<0.355.

14. A display backlight as claimed in claim 13, wherein the LEDs have the following characteristics—blue LEDS of dominant wavelength in the range from 475-485 nm, red-orange LEDs of dominant wavelength in the range from 613-621 nm, and white LEDs of white point with chromaticity coordinates in the C.I.E. 1931 Chromaticity Diagram in the range of 0.301<x<0.316 and 0.322<y<0.355.

15. A display backlight as claimed in claim 8, wherein the group of at least three chromaticities include specifically four chromaticities which characterize the LEDs as being of types blue, green, red-orange and amber.

16. A display backlight as claimed in claim 15, wherein the LEDs have the following characteristics—blue LEDS of dominant wavelength in the range from 460-490 nm, green LEDs of dominant wavelength in the range from 520-550 nm, red-orange LEDs of dominant wavelength in the range from 613-621 nm, and amber LEDs of dominant wavelength in the range from 584-597 nm.

17. A display backlight as claimed in claim 16, wherein the LEDs have the following characteristics—blue LEDS of dominant wavelength in the range from 475-485 nm, green LEDs of dominant wavelength in the range from 540-550 nm, red-orange LEDs of dominant wavelength in the range from 613-621 nm, and amber LEDs of dominant wavelength in the range from 592-597 nm.

18. A display backlight as claimed in claim 8, wherein the LEDs include combinations of red and amber LEDs, driven at appropriate levels to produce red light.

19. A display comprising a backlight according to claim 1.

20. A medical display comprising a backlight according to claim 1.
